(19) United States
(12) Patent Application Publication
(10) Pub. No.: US 2009/0192910 A9
(43) Pub. Date: Jul. 30, 2009

(54) Systems and methods for supplying ink and toner cartridges

(75) Inventors: Scott M. Rankin, Holliston, MA (US); Jeremy Pee, Brookline, MA (US)

Correspondence Address: WOLF GREENFIELD & SACKS, P.C., 600 ATLANTIC AVENUE, BOSTON, MA, 02210-2206, US

(73) Assignee: Staples the Office Superstore, LLC, Framingham, MA (US)

(21) Appl. No.: 11/502,782

(22) Filed: Aug. 11, 2006

(51) Int. Cl. G06Q 30/00

(52) U.S. Cl. 705/26

(57) ABSTRACT

Embodiments of the invention relate to systems and methods for supplying ink or toner cartridges to a customer as part of a cartridge purchase program. One embodiment is directed to a method that involves receiving, in a receptacle, a used ink or toner cartridge from a customer, identifying the customer from customer identification information associated with the receptacle, and identifying the model of the used cartridge. The method further involves sending a replacement ink or toner cartridge to the customer of the same model as the used cartridge, and billing the customer for the replacement ink or toner cartridge.

### FIELD OF THE INVENTION

The invention is generally directed to systems and methods for supplying office supplies, and more particularly to systems and methods for supplying ink and toner cartridges.

### BACKGROUND OF THE INVENTION

Replacing ink or toner cartridges is a recurring need for many businesses and individuals. As ink or toner cartridges are depleted, replacement cartridges must be purchased. The purchase of replacement cartridges can be frustrating for customers because of the large number of cartridges on the market. The customer is required to know the specific make and model of the printer, fax, or copy machine in need of ink or toner to identify a compatible replacement cartridge. This information is often not readily available to a customer, for example if the customer is shopping and does not have the make and model information on hand. Even when customers do have the information required to identify a compatible cartridge, locating the cartridge can be daunting. Hundreds of cartridge types exist, requiring the customer to sort through many options to find a match.

The difficulties of purchasing ink and toner cartridges are compounded by the frequency with which ink and toner cartridges must be replaced. Bulk purchasing for future use is generally not a viable option, because of the limited shelf life of ink and toner cartridges. Furthermore, it can be difficult to predict how many ink or toner cartridges of a particular type will be needed before the corresponding printer, fax, or copy machine is upgraded and a new type of cartridge will be required.

### SUMMARY OF THE INVENTION

In view of the foregoing, there is a need for improved systems and methods for supplying ink and toner cartridges to customers.

One embodiment of the invention is directed to a method for supplying an ink or toner cartridge comprising acts of receiving, in a receptacle, a used ink or toner cartridge from a customer; identifying the customer from customer identification information associated with the receptacle; identifying the model of the used cartridge; sending, to the customer, a replacement ink or toner cartridge of the same model as the used cartridge; and billing the customer for the replacement ink or toner cartridge.

Another embodiment of the invention is directed to a method for supplying an ink or toner cartridge comprising acts of sending, to a customer, an envelope comprising a barcode that encodes a unique customer identifier; receiving, in the envelope, a used ink or toner cartridge from a customer; identifying the customer from the barcode; identifying the model of the used cartridge; and sending, to the customer, a replacement ink or toner cartridge of the same model as the used cartridge and a second envelope comprising a barcode that encodes a unique customer identifier.

A further embodiment of the invention is directed to a method for supplying an ink or toner cartridge comprising acts of: providing, to a customer, a label comprising a barcode, wherein the barcode encodes a unique customer identifier; receiving, in a parcel with the label affixed thereto, a used ink or toner cartridge from a customer; identifying the customer from the barcode; identifying the model of the used cartridge; sending, to the customer, a replacement ink or toner cartridge of the same model as the used cartridge; and providing to the customer a second label comprising a barcode encoding a unique customer identifier.

Another embodiment of the invention is directed to a method of registering a customer for a cartridge purchase program using the world wide web, the method comprising acts of during a first user session, receiving first customer information from the customer, wherein the first customer information comprises the customer's name, the customer's mailing address, and the customer's billing information; storing the first customer information in memory; linking the first customer information with second customer information in memory; during a second user session different from the first user session, receiving, from the customer, the second customer information and cartridge information identifying an ink or toner cartridge for purchase; during the second user session, receiving from the customer an indication of agreement with terms or conditions of the cartridge purchase program; and using the second customer information, accessing the first customer information to register the customer for the cartridge purchase program and complete the purchase of the ink or toner cartridge.

### BRIEF DESCRIPTION OF THE DRAWINGS

FIG. 1 illustrates one embodiment of a sign-up process for a cartridge purchase program and associated systems;

FIG. 2 illustrates one embodiment of the personalized envelope shown in FIG. 1; and

FIG. 3 illustrates one embodiment of a method for purchasing a cartridge using the cartridge purchase program after the initial sign-up process of FIG. 1.

### DETAILED DESCRIPTION OF THE INVENTION

In view of the deficiencies associated with conventional methods of purchasing ink and toner cartridges, there is a need for improved systems and methods for supplying ink and toner cartridges to customers. In accordance with one embodiment of the invention, a cartridge purchase program is provided to supply ink and/or toner cartridges to customers. A customer who participates in the purchase program may order a replacement ink or toner cartridge simply by sending to the supplier a used cartridge in an envelope personalized with pre-printed customer identification information. The supplier will then send to the customer a replacement ink or toner cartridge of the same make and model as the used cartridge. In addition, the supplier may send to the customer an additional personalized envelope to be used for a future order. A personalized label, affixable to a box or other parcel, may be substituted for the personalized envelope described above. Use of such a label in connection with a box or other parcel may be preferred over the use of an envelope when a bulkier cartridge (e.g., a toner cartridge) is being sent to the supplier.

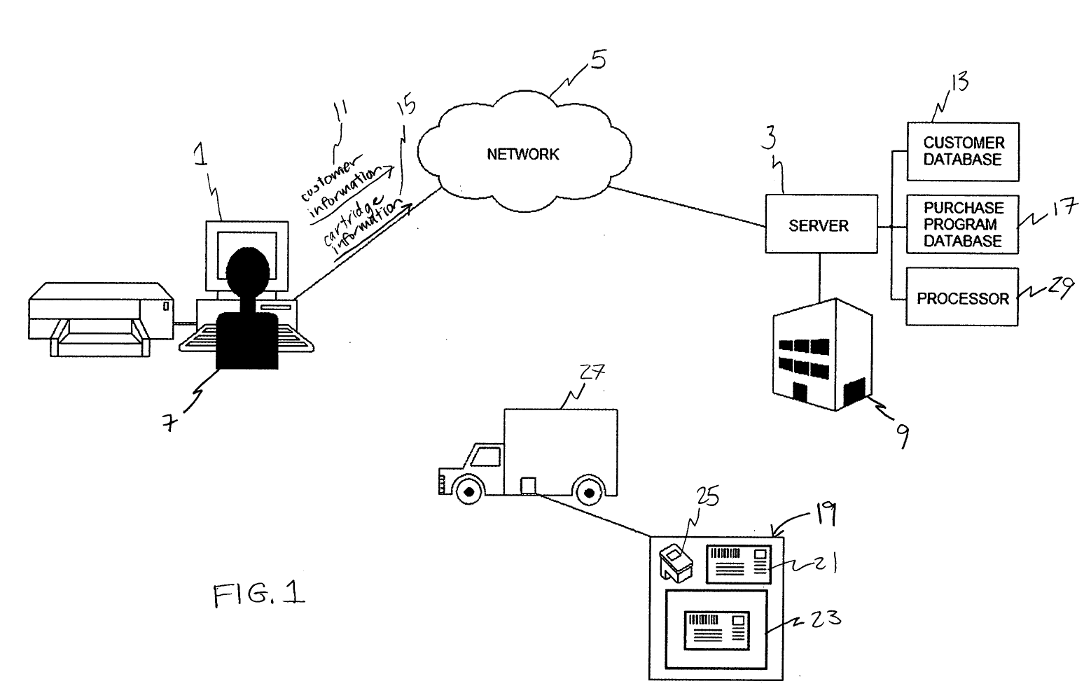

The cartridge purchase program provides several potential benefits to the customer. For example, according to some embodiments, the customer is not be required to know the make or model of the printer, fax or copy machine to complete a purchase of a corresponding replacement cartridge. In addition, the customer may be relieved of the task of identifying a compatible cartridge. Further, the customer may recycle the used cartridge in connection with the purchase of a replacement cartridge. Further discussion of these potential benefits is made in connection with FIGS. 1-3.

FIG. 1 illustrates one embodiment of a sign-up process for the cartridge purchase program. According to the process, the customer provides customer information and information regarding a first cartridge to be purchased to the supplier. The customer may also review and agree to the terms of use for the cartridge purchase program. The supplier then sends to the customer the requested cartridge, as well as materials for ordering another cartridge. The sign-up process is described in more detail below with reference to FIG. 1.

During the sign-up process, information is passed between a user interface 1 on the customer side and a server 3 on the supplier side via a network 5. The user interface 1 may comprise a personal computer, as shown, a personal digital assistant (PDA), a cellular telephone, or another device that allows information to be inputted and outputted. The server 3 may comprise a web server. The network 5 may comprise a wide area network (e.g., the Internet) and/or one or more local area networks, and may be at least partially wireless.

According to one exemplary implementation, the customer 7 and supplier 9 exchange information via the World Wide Web. In this implementation, one or more web pages provided by the server 3 convey and receive information relating to the cartridge purchase program. The user interface 1 may be configured to allow the customer 7 to access the World Wide Web, and therefore to access the web pages provided by the server 3. For example, the user interface 1 may have a web browser loaded thereon to enable the customer 7 to display and interact with the web pages for the cartridge purchase program.

The web pages may be configured to receive information 15 from the customer 7 concerning a desired cartridge. For example, the customer 7 may provide character (e.g., alphanumeric) inputs, selection inputs (e.g., by selecting a desired item or category from one or more menus), and/or other inputs via the web pages to identify a desired cartridge type. The cartridge information 15 may identify a cartridge by make and model. The customer 7 may also input a desired quantity of cartridges for each cartridge type. For example, it may be desirable to order two cartridges of each type so that one of the two cartridges will be immediately available as a replacement after the other cartridge is depleted.

To correlate the cartridge requested with the particular customer that made the request, customer information 11 is also received from the user interface 1. The customer information 11 may be provided in several ways. According to one example, the customer 7 may input the customer information 11 via the one or more web pages received from the server 3. Like the cartridge information 15, the customer information 11 may be provided using character inputs, selection inputs, and/or other inputs. The customer information 11 may comprise the customer's name, mailing address, and billing information (e.g., credit card number, expiration date, and billing address). The customer information 11 may be provided in this manner at the same time as the cartridge information 15 is supplied (e.g., in the same user session).

According to another example, the customer 7 may provide the customer information 11 merely by inputting a user name and/or password to a web page provided by the server 3. The user name and/or password may be linked with further customer information 11 (e.g., the customer's name, mailing address, and billing information), provided by the customer at an earlier time and stored in a customer database 13. The information in the customer database may be retrieved as needed during the sign-up process.

According to a further example, the user interface 1 may provide the customer information 11 to the server 3 without any active inputs from the customer. For example, a “cookie” may be sent by a web browser loaded on the user interface 1, and may identify the user interface from which the cookie originated. The user interface identifier provided by the cookie may be linked with further customer information in the customer database 13, which may be retrieved as needed.

The cartridge information 15 and customer information 11 received by the server 3 may be stored in a purchase program database 17, and may be linked in memory. In the examples described wherein further customer information is retrieved from customer database 13, the further customer information may be stored in the purchase program database 17 and linked with the cartridge information 15. Cartridge information 15 may be stored for multiple purchases over time (e.g., both past and present purchases). The stored cartridge information may be used to track purchases by a customer so that rewards may be provided to the customer for one or more purchases, to track trends for that customer or a larger sample of customers, or for some other purpose.

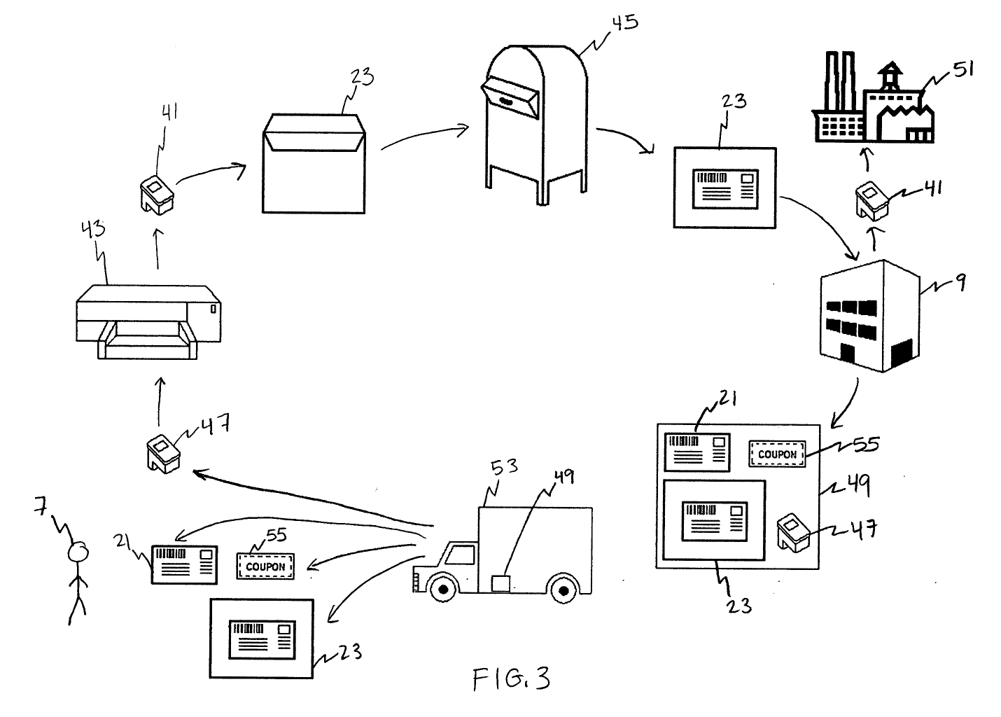

After the cartridge information 15 and customer information 11 are stored, a processor 29 may automatically generate a request for a package 19 to be assembled. The package 19 includes the requested cartridge 25, which is selected based on the cartridge information 15 supplied by the customer 7. The package 19 also includes materials to assist the customer 7 in requesting replacement cartridges. In particular, in the example of FIG. 1, the package 19 includes a label 21 and an envelope 23, either of which may be used by the customer to return the cartridge 25 (or another cartridge), once depleted, and request a replacement cartridge of the same type in the manner described in connection with FIG. 3. Of course, the package 19 is not limited to comprising one label 21 and one envelope 23, and may include other numbers (e.g., zero, one, two, three . . . ) of each. For example, it may be desirable to include one envelope 23 for each ink cartridge (if any) in the package and one label 21 for each toner cartridge (if any) in the package. It should also be appreciated that the labels 21 and envelopes 23 need not be sent with the requested cartridge 25. The labels 21 and/or envelopes 23 may be sent separately from the requested cartridge 25, and may be sent earlier than or later than the cartridge. Optionally, the supplier 9 may provide labels 21 and/or envelopes 23 at any time in response to a request by the customer 7. For example, the customer 7 may request additional labels 21 and/or envelopes 23 via telephone, the Internet, or another communication means, and the supplier 9 may send such labels to the customer.

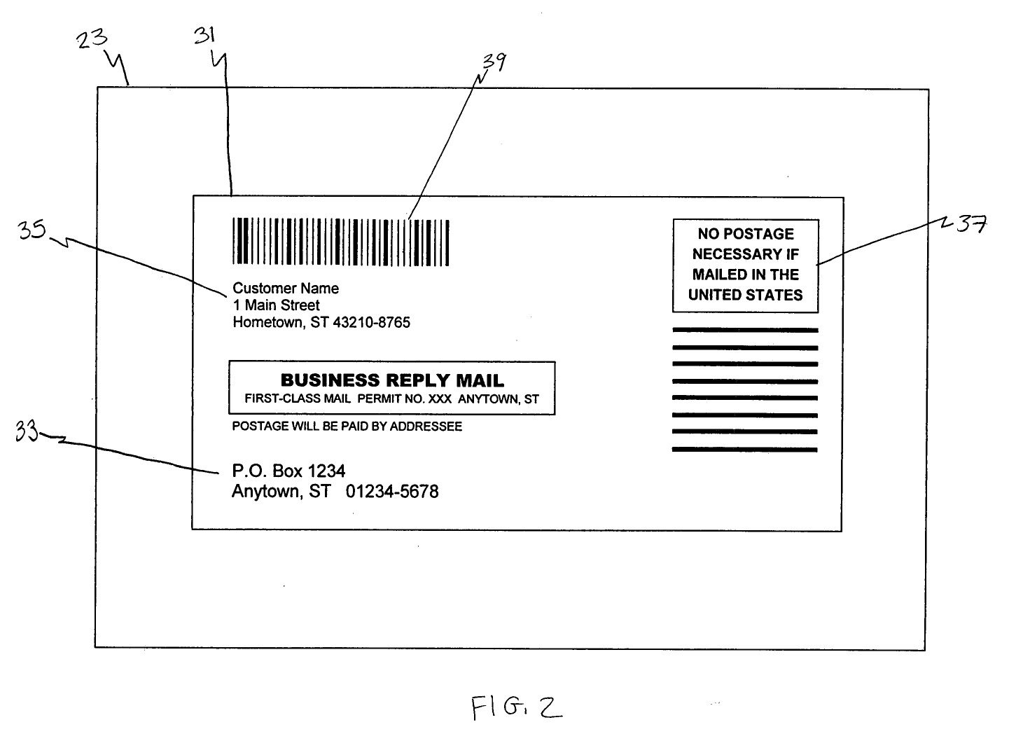

One exemplary embodiment of the envelope 23 is shown in FIG. 2. The envelope 23 includes an information portion 31 comprising an address 33 of the supplier, a return address 35 of the customer, postage paid indicia 37, and a barcode 39 that uniquely identifies the customer. The barcode 39 may encode a unique customer number that is linked in the customer database 13 or purchase program database 17 to the customer information described in connection with FIG. 1. To guard against accidental opening and leakage, the envelope may be constructed to be durable and waterproof or water resistant.

As discussed above, a label 21 may be included in the package 19 in addition to or in place of the envelope 23. The label 21 may be affixable to a box or other parcel and include the same information portion 31 as the envelope 23. The label may be affixable using an adhesive backing, tape, a pouch, or other means.

The customer 7 may be billed for the cartridge 25 upon placing the order for the cartridge via the user interface 1, upon dispatch of the package 19 to the customer, or at another suitable time. With respect to replacement cartridges sent in response to the receipt of a used cartridge by the supplier 9, as will be discussed in connection with FIG. 3, the customer 7 may be billed upon receipt of the used cartridge by the supplier 9, upon dispatch of the replacement cartridge, or at another suitable time. As part of the sign-up process, the customer 7 may be required to acknowledge and/or agree that the customer will be billed by the supplier 9 for new cartridges sent to the customer in response to the receipt of a used cartridge by the supplier.

Once assembled, the package 19 may be sent by a courier 27 to the customer 7, and its progress may be tracked by the customer (e.g., using a web site of the courier 27 or the supplier 9). The customer 7 may receive a notification (e.g., via electronic mail) indicating that they have successfully signed up for the cartridge purchase program and/or that the package 19 has been (or will soon be) sent.

If, at a later time, the customer wishes to discontinue participation in the cartridge purchase program, the customer 7 need only cease placing orders using the envelopes 23 or labels 21. Alternatively, the customer 7 may indicate via the cartridge purchase program web site or other channels that participation is no longer desired, and the customer's account may be suspended.

FIG. 3 illustrates one embodiment of a method for purchasing a cartridge using the cartridge purchase program after the initial sign-up process of FIG. 1. First, the customer 7 removes the used cartridge 41 from the printer 43, and places the cartridge in the envelope 23, described in connection with FIG. 2. The envelope 23 is pre-addressed to the supplier 9 with postage paid. The envelope 23 also includes the return address 35 of the customer 7. Therefore, the customer 7 does not need to include postage or address information on the envelope 23. The envelope 23 is simply sealed and deposited with the U.S. Postal Service, for example by deposit in a U.S. mailbox 45.

By sending the envelope 23 with the cartridge 41 to the supplier 9, the customer 7 has ordered an additional cartridge of the same type. When the envelope 23 is received by the supplier 9, the supplier will process the order and send a replacement cartridge. At the supplier 9, the envelope 23 is handled by an individual who scans the barcode 39 on the envelope 23 to identify its sender (i.e., customer 7). The barcode scanner may be linked to a computer which displays information for that customer 7. The individual then removes the cartridge 41 from the envelope 23 and determines its type (e.g., make and model). The type of the cartridge 41 may be determined by identifying make and model indicia on the cartridge, scanning a barcode on the cartridge, or some other means. After the type of the cartridge 41 is determined, the cartridge information is entered into the computer by the individual. If other cartridges are contained within the envelope 23, the information for these cartridges is also entered. Once the customer information and cartridge information has been stored, the individual may indicate (e.g., by a command entered on the computer) that all order information has been entered and that the order should be filled. The customer 7 may be billed for the order at that time, for example by charging the customer's credit card with the cost of the replacement cartridge 47. The replacement cartridge 47 may be dispatched from the warehouse of the supplier 9 where the used cartridge 41 is received, or from another warehouse selected based on its proximity to the customer 7 or some other factor.

The replacement cartridge 47 is sent to the same customer that sent the used cartridge 41 and is of the same type (e.g., make and model) as the used cartridge. As a result, the customer 7 need not actively provide any customer or cartridge information to effect a purchase of the replacement cartridge. The customer information is drawn by the supplier from the personalized envelope 23, and the cartridge information is drawn from the used cartridge 41 deposited therein.

The replacement cartridge may be sent in a package 49 (e.g., a box or envelope) via a courier 53. Preferably, the courier 53 allows the customer 7 to track the progress of the delivery. In addition to the replacement cartridge 47, the package 49 may include one or more additional personalized envelopes 23 and/or personalized labels 21. The additional personalized envelope 23 or label 21 may be used to send the replacement cartridge 47 to the supplier 9 and request a new cartridge when the replacement cartridge 47 is depleted. Products other than the replacement cartridge 47, such as other products ordered by the customer from the supplier, may also optionally be included in the package 49.

The used cartridge 41 sent to the supplier 9 in the transaction described above may be disposed of, recycled, or reused. For example, the used cartridge 41 may be sent to a facility 51 to be refurbished, so that it may be reused in part or in whole. The refurbished cartridge may be sold through the cartridge purchase program described herein or through other channels. Alternatively, the used cartridge may be broken down for recycling purposes. Refurbished cartridges, for example, are generally broken down and recycled, because the quality of the cartridge may deteriorate with continued reuse.

Because used cartridges may be beneficially refurbished or recycled, it may be desirable to offer an incentive for customers to return used cartridges. Accordingly, the customer may be offered a coupon or other reward for each one or more cartridges returned. Optionally, the coupon or other reward may be offered only for cartridges of a particular type. The coupon 55 may be provided to the customer in tangible form as part of the package 49, as shown in FIG. 3. Alternatively, the coupon may be provided to the customer in electronic form (e.g., electronic mail).

In some cases, a customer may not need a replacement cartridge, but may nevertheless desire to return the used cartridge 41 so that it may be reused or recycled. To accommodate these customers, the envelope 23 may include a checkbox or the like so that the customer may indicate that they would not like a replacement cartridge. In this manner, the customer 41 indicates that they do not intend the return of the envelope 23 with the used cartridge 41 as an order. When the envelope 23 is received at the supplier 9, the individual who processes the envelope will make note of the indication, and a replacement cartridge will not be sent.

It should be appreciated that while many of the tasks associated with processing the envelope and its contents at the supplier 9 are described as being performed manually, the tasks may alternatively be automated. For example, a device may scan the envelope to determine barcode information and marks indicating that the cartridge is for return only. Further, a handling system may be provided for the envelopes to automatically open, transport and/or route envelopes and cartridges associated with a transaction.

During the transaction, it may be desirable to keep the customer 7 informed about its status. Accordingly, electronic mail notifications or other forms of notifications may be sent to the customer 7 in response to certain events. For example, a notification may be sent to alert the customer that the used cartridge 41 has been received or that the replacement cartridge 47 has been dispatched. As discussed above, a coupon may be provided electronically to the customer 7 in response to receipt of a used cartridge 41. This electronic coupon may be provided as part of the notification confirming receipt of the used cartridge 41, if desired.

The term “cartridges” as used herein is intended to encompass both ink cartridges and toner cartridges. These cartridges may be used in printers, fax machines, copy machines, or similar devices. As discussed herein, toner cartridges tend to be larger than ink cartridges, and it therefore may be desirable to send toner cartridges in a box or other parcel rather than in an envelope. Accordingly, where used cartridge 41 is described as being sent in envelope 23 in connection with FIG. 3, it should be appreciated that a box or other parcel having a label 21 affixed thereto may alternatively be used. When a replacement cartridge 47 is desired, the customer 7 can package the used cartridge 41 in the box it arrived in or some other parcel, and affix the label 21 thereto. The box is then sent and processed in the same manner as the envelope.

The label 21 may be provided by the supplier, as discussed herein. For example, the label 21 may be sent to the customer 7 via a courier. As another example, the label 21 may be printed from the cartridge purchase program website. In particular, after the identity of customer 7 has been identified, the website may generate the label in response to a request so that it may be printed locally by the customer 7.

For simplicity, the example of FIG. 3 involved one used cartridge 41 being sent to the supplier 9 and one replacement cartridge 47 being received from the supplier in response. However, the method of FIG. 3 may be used for multiple cartridges. For example, if the customer 7 sends to the supplier 9 two used cartridges, a first cartridge of type “X” and the second cartridge of type “Y,” the customer will receive in return a replacement cartridge of type “X” and a replacement cartridge of type “Y.” In this manner, the replacement cartridges will correspond to the returned cartridges with respect to both quantity and make and model.

Although the systems and methods set forth herein are described as involving a used cartridge 41 that is sent to the supplier 9, the used cartridge alternatively may delivered to the supplier 9 directly by the customer 7. For example, an envelope 23 or labeled parcel containing the used cartridge 41 may be deposited in a container at a retail store of the supplier 9 by the customer, and the system and method may otherwise function as described herein. In particular, the supplier 9 may process the envelope 23 or parcel having a label 21 affixed thereto as described herein, and may send a replacement cartridge 47 to the customer in the manner described herein.

Further, although the systems and methods set forth herein are described as being useful for supplying ink and toner cartridges, the systems and methods may also be used for supplying other products. For example, the systems and methods may also be used for supplying pens, corrective fluid, other office products, film, batteries, compact disks (CDs), cleaning products, and medical or healthcare supplies (e.g., catheters, protective covers, etc.). Thus, once one of the aforementioned products has been depleted or otherwise used, it may be returned to the supplier using a personalized envelope or label, and a replacement product may be sent in response to receipt of the depleted product according to the principles described herein. Having described several illustrative embodiments of the invention, various alterations, modifications and improvements will readily occur to those skilled in the art. Such alterations, modifications and improvements are intended to be in the spirit and scope of the invention. Accordingly, the foregoing description is by way of example only and is not intended as limiting. The invention is limited only as defined in the following claims and the equivalence thereto.

What is claimed is:

1. A method for supplying an ink or toner cartridge comprising acts of:
receiving, in a receptacle, a used ink or toner cartridge from a customer;
identifying the customer from customer identification information associated with the receptacle;
identifying the model of the used cartridge;
sending, to the customer, a replacement ink or toner cartridge of the same model as the used cartridge; and
billing the customer for the replacement ink or toner cartridge.

2. The method of claim 1, wherein the receptacle is a personalized envelope, and wherein the method further comprises acts of:
generating the personalized envelope with the customer identification information located on an exterior thereof; and
prior to the act of receiving, sending the personalized envelope to the customer.

3. The method of claim 1, wherein the method further comprises acts of:
generating a personalized label with the customer identification information located thereon; and
sending the personalized label to the customer;
wherein the act of receiving comprises receiving the used ink or toner cartridge in a receptacle having the personalized label affixed thereto.

4. The method of claim 1, wherein the method further comprises an act of:
providing a web site for the customer to electronically generate a personalized label with the customer identification information located thereon, wherein the electronically generated personalized label may be printed by the customer to form a printed personalized label;
wherein the act of receiving comprises receiving the used ink or toner cartridge in a receptacle having the printed personalized label affixed thereto.

5. The method of claim 1, wherein the customer identification information is located on an exterior of the receptacle.

6. The method of claim 1, wherein the customer identification information comprises a barcode encoded with a unique customer identifier.

7. The method of claim 1, further comprising an act of recycling the used cartridge.

8. The method of claim 1, further comprising an act of refurbishing at least a portion of the used cartridge.

9. The method of claim 1, further comprising providing a coupon the customer in response to the act of receiving.

10. A method for supplying an ink or toner cartridge comprising acts of:
sending, to a customer, an envelope comprising a barcode that encodes a unique customer identifier;
receiving, in the envelope, a used ink or toner cartridge from a customer;
identifying the customer from the barcode;
identifying the model of the used cartridge; and
sending, to the customer, a replacement ink or toner cartridge of the same model as the used cartridge and a second envelope comprising a barcode that encodes a unique customer identifier.

11. The method of claim 10, wherein the act of sending comprises sending the replacement cartridge in a receptacle with the second envelope.

12. The method of claim 10, further comprising an act of
receiving, in the second envelope, the replacement cartridge from the customer.

13. A method for supplying an ink or toner cartridge comprising acts of:
providing, to a customer, a label comprising a barcode, wherein the barcode encodes a unique customer identifier;
receiving, in a receptacle with the label affixed thereto, a used ink or toner cartridge from a customer;
identifying the customer from the barcode;
identifying the model of the used cartridge;
sending, to the customer, a replacement ink or toner cartridge of the same model as the used cartridge; and
providing to the customer a second label comprising a barcode encoding a unique customer identifier.

14. The method of claim 13, further comprising an act of:
receiving, in a receptacle with the second label affixed thereto, the replacement cartridge from the customer.

15. The method of claim 13, wherein the act of providing the second label comprises sending the second label to the customer with the replacement cartridge.

16. The method of claim 13, wherein the act of providing the second label comprises generating an electronic image of the second label.

17. A method of registering a customer for a cartridge purchase program using the world wide web, the method comprising acts of:
during a first user session, receiving first customer information from the customer, wherein the first customer information comprises the customer's name, the customer's mailing address, and the customer's billing information;
storing the first customer information in memory;
linking the first customer information with second customer information in memory;
during a second user session different from the first user session, receiving, from the customer, the second customer information and cartridge information identifying an ink or toner cartridge for purchase; and
using the second customer information, accessing the first customer information to register the customer for the cartridge purchase program and complete a purchase of the ink or toner cartridge.

18. The method of claim 17, wherein the second customer information comprises a user name and a password.

19. The method of claim 17, wherein the second customer information comprises a user interface identifier.

20. The method of claim 17, further comprising an act of:
during the second user session, receiving from the customer an indication of agreement with terms or conditions of the cartridge purchase program.
